(19) United States
(12) Patent Application Publication
(10) Pub. No.: US 2006/0146077 A1
(43) Pub. Date: Jul. 6, 2006

(54) Jetting performance tester usable with jetting heads

(76) Inventors: Se Kyong Song, Yongin-Si (KR); Dong Eog Kim, Suwon-si (KR); Jong-Han Oh, Yongin-Si (KR); Seung Hwang Yi, Suwon-Si (KR)

Correspondence Address: STANZIONE & KIM, LLP, 919 18TH STREET, N.W., SUITE 440, WASHINGTON, DC, 20006, US

(21) Appl. No.: 11/168,395

(22) Filed: Jun. 29, 2005

(30) Foreign Application Priority Data
Dec. 30, 2004 (KR) 2004-116545

(51) Int. Cl. B41J 3/00

(52) U.S. Cl. 347/2

(57) ABSTRACT

A jetting performance tester designed to evaluate jetting performance of a plurality of jetting heads each having a plurality of nozzles, after real-time measurement of jetting conditions of droplets ejected from the plurality of jetting heads. The jetting performance tester includes a camera unit to detect droplets ejected from the jetting heads, a driving unit to provide relative movement between the jetting heads and the camera unit in two or more directions orthogonal to each other, and a controller to evaluate jetting performance of the jetting heads based on jetting conditions of the droplets detected by the camera unit.

### CROSS-REFERENCE TO RELATED APPLICATIONS

This application claims the benefit under 35 U.S.C. § 119 of Korean Patent Application No. 2004-116545, filed on Dec. 30, 2004 in the Korean Intellectual Property Office, the disclosure of which is incorporated herein in its entirety by reference.

### BACKGROUND OF THE INVENTION

1. Field of the Invention

The present general inventive concept relates to a jetting performance tester usable with a plurality of jetting heads, and more particularly, to a driving mechanism of a jetting performance tester, which evaluates jetting performance of a plurality of jetting heads after real-time measurement of jetting conditions of droplets ejected from the plurality of jetting heads.

2. Description of the Related Art

In semiconductor processing, photolithography is a process of uniformly applying a photosensitive material called a photoresist to a wafer by exposing the wafer through a mask or a reticle to light in an exposure apparatus called a stepper or scanner, such that a predetermined pattern of the mask or the reticle is reduced in size and then projected onto the wafer to form a desired image thereon. The photoresist is then developed to form a photoresist film having a desired two-dimensional image on the wafer. Since the photolithography process can provide an excellent film having uniformity in thickness and width, it has been widely applied in semiconductor device fabrication. However, as a degree of integration on the wafer increases, problems appear in that when forming a minute pattern on the wafer using a conventional photolithography process, it is necessary to provide expensive equipment, wafer yields are lowered, and the like.

In order to solve these problems, various investigations have been performed which can replace the conventional photolithography process, and in particular, there has been an investigation into printing technologies, which do not use a light source. Among the printing technologies, ink-jet printing has been touted as the most promising solution. Although initially, ink-jet printing technology was developed for home printers, it has recently been expanded in usage to applications such as color filters for liquid crystal display panels, optical switch diodes, organic light emitting diodes, subminiature sensors, and the like. Ink-jet printing uses a non-contact printing method, thereby maximizing the productivity of the semiconductor device due to minimized generation of defective products.

The present general inventive concept relates to a tester to inspect/evaluate jetting performance of jetting heads available in such ink-jet printing equipment. Droplets ejected from the jetting heads include metallic materials as well as liquids (such as ink), and can be determined according to product type.

FIG. 1 illustrates a conventional jetting performance tester for jetting heads of ink-jet printing equipment. Referring to FIG. 1, the construction of the conventional jetting performance tester will now be described.

The conventional tester is adapted to inspect a droplet ejected by a single jetting head 10. The jetting head 10 has a plurality of nozzles 11 arranged in a line. A camera 20 is installed a predetermined distance apart from the jetting head 10 to measure jetting conditions of droplets 50 ejected by the nozzles 11. The camera 20 is provided with a single-shaft motor 30 for driving the camera 20 in a direction in which the nozzles 11 are arranged, so as to sequentially inspect the plurality of nozzles 11. Additionally, the conventional tester is provided with a controller 40 to control operations of the jetting head 10 and the camera, and a display unit 41 to display an image taken by the camera 20. The controller 40 serves to control overall operations of the conventional tester, and to evaluate the jetting performance of the jetting head 10 based on the jetting conditions of the droplet measured by the camera 20. In the specification, the term “jetting conditions” means outer size, diameter, injection velocity, injection straightness, existence of a tail in a droplet ejected by each nozzle, and the like.

Operation of the conventional jetting performance tester as described above will be described below.

As the conventional jetting performance tester initiates inspection, the controller 40 activates the motor 30 to move the camera 20 such that the camera 20 is located to measure jetting conditions of a droplet ejected by a first nozzle of the plurality of nozzles 11 positioned at an uppermost position of the jetting head 10. After detecting the droplet ejected by the first nozzle, the controller 40 activates the motor 30 to move the camera 20 such that the camera 20 measures the jetting conditions of a droplet ejected by a second nozzle of the plurality of nozzles 11 and the rest of the plurality of nozzles 11 while horizontally moving in parallel with the arrangement of the nozzles 11. The controller 40 evaluates the jetting performance of the jetting head 10 based on the jetting conditions of the droplets 50 measured by the camera 20.

However, such a conventional jetting performance tester has problems as described below.

Generally, equipment using ink-jet printing technology has a plurality of jetting heads in order to enhance a producing rate and a producing efficiency of products. In this regard, since a camera of a conventional tester is fixed at a position corresponding to a focal length of the camera set to one jetting head, there is a problem in that the camera cannot detect droplets ejected from the other jetting heads located at a position deviated from the focal length of the camera.

Additionally, since a pick-up angle of the camera to the droplet is preset to a fixed angle, there is difficulty in three-dimensional analysis of the droplet. The term “three-dimensional analysis” means that the droplet is detected at different angles to measure the jetting conditions of the droplet at the different angles.

Additionally, since the droplets ejected by the plurality of nozzles of the jetting head are inspected by a single camera, there is a problem of lengthy inspection time.

### SUMMARY OF THE INVENTION

The present general inventive concept provides a jetting performance tester usable with a plurality of jetting heads, designed to inspect jetting conditions of droplets ejected from the plurality of jetting heads.

The present general inventive concept also provides a jetting performance tester usable with a plurality of jetting heads, designed to allow three-dimensional analysis of droplets ejected from the plurality of jetting heads.

The present general inventive concept also provides a jetting performance tester usable with a plurality of jetting heads, designed to reduce inspection time of jetting performance, thereby enhancing inspection efficiency.

Additional aspects and/or advantages of the general inventive concept will be set forth in part in the description which follows and, in part, will be obvious from the description, or may be learned by practice of the general inventive concept.

The foregoing and/or other aspects and advantages of the present general inventive concept are achieved by providing a jetting performance tester usable with one or more jetting heads, each having a plurality of nozzles, the jetting performance tester including a camera unit to detect droplets ejected from the jetting heads, a driving unit to provide relative movement between the jetting heads and the camera unit in two or more directions orthogonal to each other, and a controller to evaluate jetting performance of the jetting heads based on jetting conditions of the droplets detected by the camera unit.

The driving unit may include a rotational driver to change a pick-up angle of the camera unit.

The camera unit may include two or more cameras. The two or more cameras may be disposed in parallel with each other so as to detect the droplets ejected by two or more nozzles simultaneously. Alternatively, the two or more cameras may be disposed at a predetermined angle with respect to one another so as to detect a droplet ejected by one nozzle at different angles simultaneously.

The driving unit may include an X-axis driver to provide relative movement between the jetting heads and the camera unit in a longitudinal direction of the jetting heads, a Y-axis driver to provide relative movement between the jetting heads and the camera unit in a width direction of the jetting heads, and a Z-axis driver to provide relative movement between the jetting heads and the camera unit in a height direction of the jetting heads. The X-axis driver, the Y-axis driver and the Z-axis driver may be disposed at one of the jetting heads and the camera unit.

The foregoing and/or other aspects and advantages of the present general inventive concept are also achieved by providing a jetting performance tester usable with one or more jetting heads, each having a plurality of nozzles, the jetting performance tester including a camera unit to detect droplets ejected from the jetting heads, a rotational driver to provide relative rotation between the jetting heads and the camera unit so as to change a pick-up angle of the camera unit, and a controller to evaluate jetting performance of the jetting heads based on jetting conditions of the droplets detected by the camera unit.

The jetting performance tester may further include an X-axis driver to provide relative movement between the jetting heads and the camera unit in a longitudinal direction of the jetting heads, a Y-axis driver to provide relative movement between the jetting heads and the camera unit in a width direction of the jetting heads, and a Z-axis driver to provide relative movement between the jetting heads and the camera unit in a height direction of the jetting heads.

The camera unit may include two or more cameras. The two or more cameras may be disposed in parallel with each other so as to detect the droplets ejected by two or more nozzles simultaneously. Alternatively, the two or more cameras may be disposed at a predetermined angle with respect to one another so as to detect a droplet ejected by one nozzle at different angles simultaneously.

The foregoing and/or other aspects and advantages of the present general inventive concept are also achieved by providing a jetting performance tester usable with one or more jetting heads each having a plurality of nozzles, the jetting performance tester including a camera unit comprising two or more cameras to detect droplets ejected from the jetting heads, a driving unit to provide relative movement of the camera unit with respect to the jetting heads, and a controller to evaluate jetting performance of the jetting heads based on jetting conditions of the droplets detected by the camera unit.

The two or more cameras may be disposed in parallel with each other so as to detect the droplets ejected by two or more nozzles simultaneously. Alternatively, the two or more cameras may be disposed at a predetermined angle with respect to one another so as to detect a droplet ejected by one nozzle at different angles simultaneously.

### BRIEF DESCRIPTION OF THE DRAWINGS

These and/or other aspects and advantages of the general inventive concept will become apparent and more readily appreciated from the following description of the embodiments, taken in conjunction with the accompanying drawings, of which:

FIG. 1 is a schematic perspective view illustrating a conventional jetting performance tester for jetting heads of ink-jet printing equipment;

FIG. 2 is a top view illustrating a jetting performance tester usable with one or more jetting heads according to an embodiment of the present general inventive concept;

FIG. 3 is a schematic perspective view illustrating the jetting performance tester of FIG. 2;

FIG. 4 is a conceptual view illustrating a pick-up operation of the jetting performance tester of FIG. 2 according to different pick-up angles; and

FIG. 5 is a schematic perspective view illustrating a jetting performance tester usable with one or more jetting heads according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

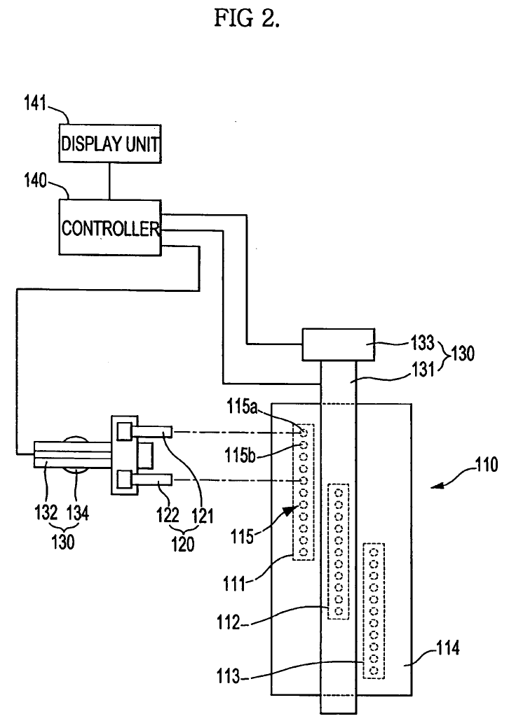

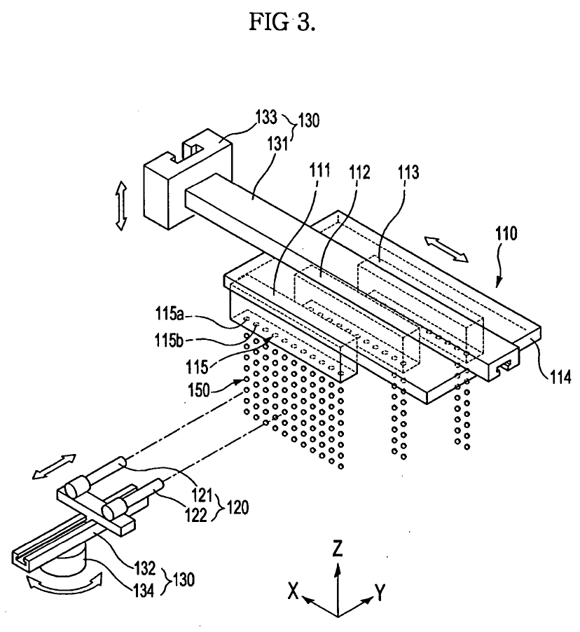

FIGS. 2 and 3 illustrate a jetting performance tester usable with one or more jetting heads according to an embodiment of the present general inventive concept. Referring to FIGS. 2 and 3, the jetting performance tester tests a jetting performance of several jetting heads 111, 112 and 113 disposed in one direction. Each of the jetting heads 111, 112 and 113 has a plurality of nozzles 115 formed through a bottom surface thereof and arranged in a line in a longitudinal direction of the jetting head. The nozzles 115 serve to eject droplets 150, such as ink, metallic materials, and the like. As illustrated in FIGS. 2 and 3, the jetting heads 111, 112 and 113 are disposed in parallel with one another. Disposition of the jetting heads 111, 112 and 113 may be changed as necessary, and even though three jetting heads 111, 112 and 113 are illustrated in FIGS. 2 and 3, the number of jetting heads may also be varied. The jetting heads 111, 112 and 113 are equipped at a head frame 114, which serves to fix a relative position between the jetting heads 111, 112 and 113. The head frame 114 and the jetting heads 111, 112 and 113 constitute a head unit 110.

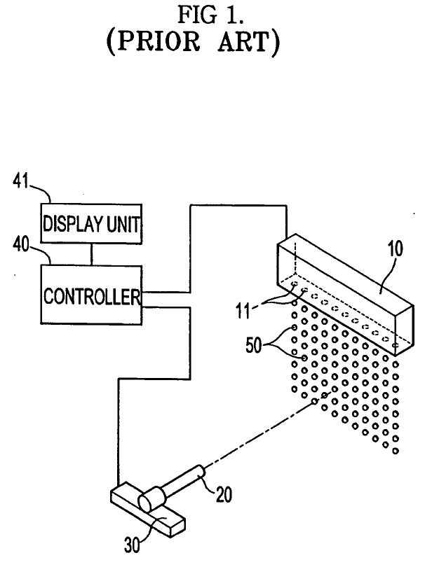

A camera unit 120 is provided at one side of the head unit 110 to measure jetting conditions of the droplets 150 ejected by the nozzles 115. The camera unit 120 may comprise two cameras 121 and 122 disposed in parallel to each other. A distance between the camera unit 120 and the head unit 110 is determined according to a focal length of the cameras 121 and 122. That is, the camera unit 120 is spaced a predetermined distance from the head unit 110 such that the droplets 150 to be detected by the camera unit 120 are located at the focal length of the cameras 121 and 122. The respective cameras 121 and 122 measure the jetting conditions of the droplets 150 ejected by different nozzles 115 simultaneously to reduce the time required to measure the jetting conditions of the droplets 150 ejected by all of the nozzles 115 of one of the jetting heads 111, 112 and 113. Although FIGS. 2 and 3 illustrate two cameras 121 and 122, the number of the cameras is not limited to two, but may be increased to a certain number m as necessary. As a result, an inspection time of one jetting head using the jetting performance tester is reduced to 1/m times an inspection time of a conventional jetting performance tester such as that illustrated in FIG. 1.

Additionally, the jetting performance tester comprises a driving unit 130 to provide relative movement between the camera unit 120 and the head unit 110. The driving unit 130 is configured to provide relative movement between the camera unit 120 and the head unit 110 in the longitudinal direction, in a width direction, and in a height direction of the jetting heads 111, 112 and 113. For convenience of description, as illustrated in FIG. 2, the longitudinal direction, the width direction, and the height direction of the jetting heads 111, 112 and 113 will be referred to as the X-axis, the Y-axis, and the Z-axis, respectively, hereinafter. The driving unit 130 comprises an X-axis driver 131 to provide linear movement of the head unit 110 in the longitudinal direction (the X-axis direction) of the jetting heads 111, 112 and 113, a Z-axis driver 133 to provide linear movement of the head unit 110 in the height direction (the Z-axis direction) of the jetting heads 111, 112 and 113, and a Y-axis driver 132 to provide linear movement of the camera unit 120 in the width direction (the Y-axis direction) of the jetting heads 111, 112 and 113. The driving unit 130 further comprises a rotational driver 134 to rotate the camera unit 120 with respect to the head unit 110 in order to change a pick-up angle of the camera unit 120. Each of the X-axis driver 131, the Y-axis driver 132, the Z-axis driver 133, and the rotational driver 134 is provided to provide relative movement between the head unit 110 and the camera unit 120. In FIGS. 2 and 3, the X-axis driver 131 and the Z-axis driver 133 are installed at the head unit 110, while the Y-axis driver 132 and the rotational driver 134 are installed at the camera unit 120. However, it should be understood that the present general inventive concept is not limited to this construction, and the respective drivers 131, 132, 133 and 134 can be installed at the head unit 110 or at the camera unit 120 as long as the installation of the drivers 131, 132, 133 and 134 ensures the relative movement between the head unit 110 and the camera unit 120.

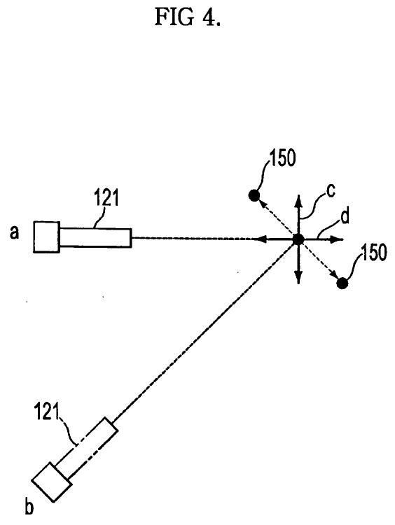

The pick-up angle of the camera unit 120 is changed to inspect straightness of the droplets 150 ejected by the nozzles 115. The inspection of the straightness of the droplets 150 ejected by the nozzles 115 is an inspection as to whether the droplets 150 are ejected in a vertically downward direction by the nozzle 115. As illustrated in FIG. 4, when a droplet 150 is ejected downward by the nozzle 115 in a slightly deviated state from a vertical center line of the nozzle 115, if the camera 121 is located at a position “a,” there is a limitation in that the camera 121 can detect a deviation “c” in a left direction or a right direction with respect to a front of the camera 121, but the camera 121 cannot detect a deviation “d” in a forward direction or a backward direction with respect to the front of the camera 121. Thus, if the camera 121 is located at a position “b” providing a different pick-up angle from the position “a,” the camera can detect the deviation “d,” which cannot be detected at the position “a.” Accordingly, upon inspection of the straightness of an ejected droplet 150, it is necessary to detect the droplet 150 in three-dimensions at two or more pick-up angles in order to ensure an accurate inspection.

The jetting performance tester further comprises a controller 140 to control overall operations of the head unit 110, the camera unit 120, and the driving unit 130, and a display unit 141 to display an image captured by the camera unit 120. The controller 140 also has a function of evaluating the jetting performance of the jetting heads 111, 112 and 113 using the jetting conditions of the droplet 150 measured by the camera unit 120.

Operations of the jetting performance tester of FIGS. 2 and 3 will now be described.

The X-axis driver 131 causes relative movement of the camera unit 120 with respect to the jetting heads 111, 112 and 113 in the longitudinal direction of the jetting heads 111, 112 and 113, and thus serves to change a target nozzle 115, which becomes a detecting target in one of the jetting heads 111, 112 and 113. The Y-axis driver 132 causes relative movement of the camera unit 120 with respect to the jetting heads 111, 112 and 113 in the width direction of the jetting heads 111, 112 and 113, and thus serves to change a target jetting head, which becomes a detecting target among the jetting heads 111, 112 and 113. The Z-axis driver 133 causes relative movement of the camera unit 120 with respect to the jetting heads 111, 112 and 113 in the height direction of the jetting heads 111, 112 and 113, and thus serves to measure jetting conditions according to an ejected height. Additionally, the rotational driver 134 causes relative rotation of the camera unit 120 with respect to the jetting heads 111, 112 and 113, and thus serves to change the pick-up angle of the camera unit 120.

The jetting performance tester is operated as described below. For convenience of description, the jetting heads 111, 112 and 113 will be referred to as first, second, and third jetting heads 111, 112 and 113, respectively. In the first jetting head 111, an uppermost nozzle and a next nozzle will be referred to as first and second nozzles 115a and 115b, respectively. In the camera unit 120, the cameras 121 and 122 will be referred to as first and second cameras 121 and 122, respectively.

As the jetting performance tester starts inspecting, the controller 140 activates the driving unit 130 to locate the first camera 121 at a position to measure the jetting conditions of a droplet 150 ejected by the first nozzle 115a of the first jetting head 111. The second camera 122 measures jetting conditions of another droplet 150 ejected by another nozzle 115 positioned at a center portion of the first jetting head 111.

After the camera unit 120 measures the jetting conditions of the droplets 150 ejected by the first nozzle 115a and the nozzle 115 positioned at the center portion of the first jetting head 111, the controller 140 activates the X-axis driver 131 to sequentially detect droplets 150 ejected by the second nozzle 115b and the rest of the nozzles 115 of the first jetting head 111.

After the camera unit 120 measures the jetting conditions of the droplets 150 ejected by all of the nozzles 115 of the first jetting head 111, the controller 140 activates the Y-axis driver 132 to move the camera unit 120 to a position to measure jetting conditions of droplets 150 ejected from the second jetting head 112. The Y-axis driver 132 moves the camera unit 120 such that the droplets 150 ejected from the second jetting head 112 are located at a focal length of the cameras 121 and 122. Then, the controller 140 activates the X-axis driver 131 to sequentially measure jetting conditions of droplets 150 ejected by the respective nozzles 115 of the second jetting head 112. After the camera unit 120 measures the jetting conditions of the droplets 150 ejected by all of the nozzles 115 of the second jetting head 112, the controller 140 activates the X-axis driver 131 and the Y-axis driver 132 to measure the jetting conditions of the droplets 150 ejected by the third jetting head 113 with the same method as described above.

Then, after the camera unit 120 measures the jetting conditions of the droplets 150 ejected from the respective jetting heads 111, 112 and 113, jetting conditions of the droplets according to the height or the pick-up angle are measured. To measure the jetting conditions of the droplets 150 according to the height, the controller 140 activates the Z-axis driver 133 to change a height difference between the camera unit 120 and the head unit 110, and the camera unit 120 measures the jetting conditions of the droplets 150 at the changed height difference by repeating the process as described above. To measure the jetting conditions of the droplets 150 according to the pick-up angle, the controller 140 activates the rotational driver 134 to change the pick-up angle of the camera unit 120, and the camera unit 120 measures the jetting conditions of the droplets 150 at the changed pick-up angle by repeating the process as described above.

Information obtained by the camera unit 120 is transmitted to the controller 140, which makes a real-time evaluation of the information regarding size, diameter, jetting speed, straightness, existence of tail, and the like according to an algorithm implemented as a program in the controller 120, thereby inspecting the performance of the jetting heads 111, 112 and 113.

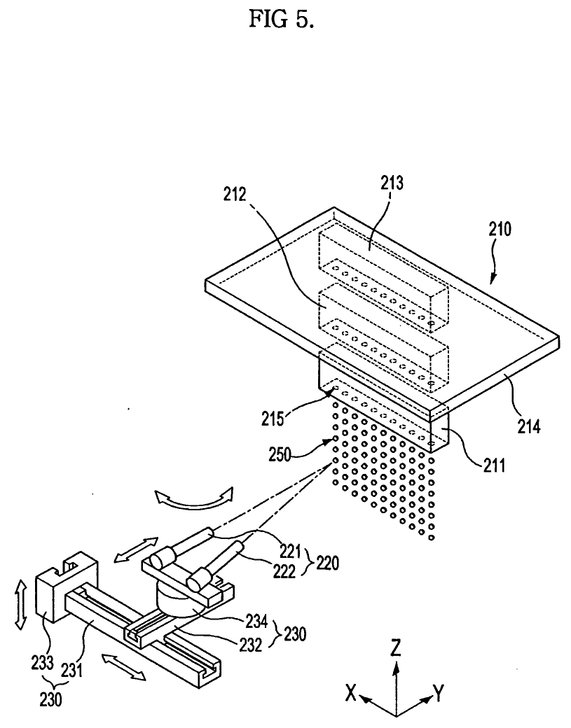

FIG. 5 illustrates a jetting performance tester usable with one or more jetting heads according to another embodiment of the present general inventive concept. Referring to FIG. 5, the jetting performance tester will be described as follows.

A plurality of jetting heads 211, 212 and 213 having an elongated bar shape are disposed in parallel with one another on a head frame 214, constituting a head unit 210. Unlike the jetting heads 111, 112 and 113 of FIGS. 2 and 3, the jetting heads 211, 212 and 213 of FIG. 5 are arranged vertically, and the arrangement can be variously changed as necessary.

A camera unit 220 is provided a predetermined distance apart from the head unit 210 to measure jetting conditions of droplets 250 ejected from the jetting heads 211, 212 and 213. The camera unit 220 comprises a plurality of cameras 221 and 222, which are disposed at a predetermined angle with respect to each other so as to detect a droplet 250 ejected by a certain nozzle at different pick-up angles simultaneously. That is, the camera unit 220 is configured to detect the droplet 250 in three dimensions. In FIG. 5, two cameras 221 and 222 are shown, but the present general inventive concept is not limited to this construction. That is, two or more cameras may be arranged to have different pick-up angles.

A driving unit 230 is provided below the camera unit 220 in order to provide relative movement between the camera unit 220 and the head unit 210. The driving unit 230 comprises an X-axis driver 231, a Y-axis driver 232, and a Z-axis driver 233 to provide relative movements between the camera unit 220 and the head unit 210 in a longitudinal direction, a width direction, and a height direction of the jetting heads 211, 212 and 213, respectively. The driving unit 230 further comprises a rotational driver 234 to rotate the camera unit 220 with respect to the head unit 210. The jetting performance tester of FIG. 5 is different from the jetting performance tester of FIGS. 1 and 2 in that the X-axis driver 231 and the Z-axis driver 233 are not equipped at the head unit 210 but at the camera unit 220. However, in spite of the difference in disposition of the X-axis driver 231 and the Z-axis driver 233, the X-axis driver 231 and the Z-axis driver 233 provide relative movements between the camera unit 220 and the head unit 210 in the X-axis direction and the Z-axis direction, respectively.

Additionally, although not shown in the drawings, the jetting performance tester of the embodiment of FIG. 5 comprises a controller and a display unit similar to that illustrated in FIG. 2.

Operations of the jetting performance tester of FIG. 5 are approximately the same as that of the jetting performance tester of FIGS. 2 and 3. The difference between the jetting performance tester of FIGS. 2 and 3 and the jetting performance tester of FIG. 5 is that the jetting performance tester of FIGS. 2 and 3 has the plurality of cameras 121 and 122 adapted to detect the droplets 150 ejected by the different nozzles 115 at an identical pick-up angle, whereas the jetting performance tester of FIG. 5 has the plurality of cameras 221 and 222 adapted to detect a droplet 250 ejected by one nozzle 215 at different pick-up angles simultaneously.

As apparent from the above description, a jetting performance tester usable with one or more jetting heads according to the present general inventive concept is provided with a driving unit configured to allow a head unit and a camera unit to move relative to each other in the three axis directions orthogonal to one another, thereby allowing a jetting performance test of the head unit including a plurality of jetting heads, and is configured to provide various inspecting positions, thereby enhancing a reliability of inspection.

Furthermore, a jetting performance tester usable with one or more jetting heads according to the present general inventive concept is provided with a rotational driver configured to allow a camera unit to change a pick-up angle of a droplet ejected by a nozzle, thereby enabling three dimensional analysis of the droplet ejected by the nozzle.

Furthermore, a jetting performance tester usable with one or more jetting heads according to the present general inventive concept is provided with a plurality of cameras, thereby enabling reduction in inspection time.

Although a few embodiments of the present general inventive concept have been shown and described, it would be appreciated by those skilled in the art that changes may be made in this embodiment without departing from the principles and spirit of the general inventive concept, the scope of which is defined in the claims and their equivalents.

What is claimed is:

1. A jetting performance tester usable with one or more jetting heads each having a plurality of nozzles, the jetting performance tester comprising:
a camera unit to detect droplets ejected from the jetting heads;
a driving unit to provide relative movement between the jetting heads and the camera unit in two or more directions orthogonal to each other; and
a controller to evaluate jetting performance of the jetting heads based on jetting conditions of the droplets detected by the camera unit.

2. The jetting performance tester according to claim 1, wherein the driving unit comprises a rotational driver to change a pick-up angle of the camera unit.

3. The jetting performance tester according to claim 1, wherein the camera unit comprises two or more cameras.

4. The jetting performance tester according to claim 3, wherein the two or more cameras are disposed in parallel with each other to detect the droplets ejected by two or more nozzles simultaneously.

5. The jetting performance tester according to claim 3, wherein the two or more cameras are disposed at a predetermined angle with respect to one another to detect a droplet ejected by one nozzle at different pick-up angles simultaneously.

6. The jetting performance tester according to claim 1, wherein the driving unit comprises an X-axis driver to provide relative movement between the jetting heads and the camera unit in a longitudinal direction of the jetting heads, a Y-axis driver to provide relative movement between the jetting heads and the camera unit in a width direction of the jetting heads, and a Z-axis driver to provide relative movement between the jetting heads and the camera unit in a height direction of the jetting heads.

7. The jetting performance tester according to claim 6, wherein the X-axis driver, the Y-axis driver and the Z-axis driver are disposed at one of the jetting heads and the camera unit.

8. A jetting performance tester usable with one or more jetting heads each having a plurality of nozzles, the jetting performance tester comprising:
a camera unit to detect droplets ejected from the jetting heads;
a rotational driver to provide relative rotation between the jetting heads and the camera unit to change a pick-up angle of the camera unit; and
a controller to evaluate jetting performance of the jetting heads based on jetting conditions of the droplets detected by the camera unit.

9. The jetting performance tester according to claim 8, further comprising:
an X-axis driver to provide relative movement between the jetting heads and the camera unit in a longitudinal direction of the jetting heads;
a Y-axis driver to provide relative movement between the jetting heads and the camera unit in a width direction of the jetting heads; and
a Z-axis driver to provide relative movement between the jetting heads and the camera unit in a height direction of the jetting heads.

10. The jetting performance tester according to claim 9, wherein the camera unit comprises two or more cameras.

11. The jetting performance tester according to claim 10, wherein the two or more cameras are disposed in parallel with each other to detect the droplets ejected by two or more nozzles simultaneously.

12. The jetting performance tester according to claim 10, wherein the two or more cameras are disposed at a predetermined angle with respect to one another to detect a droplet ejected by one nozzle at different angles simultaneously.

13. A jetting performance tester usable with one or more jetting heads each having a plurality of nozzles, the jetting performance tester comprising:
a camera unit comprising two or more cameras to detect droplets ejected from the jetting heads;
a driving unit to provide relative movement of the camera unit with respect to the jetting heads; and
a controller to evaluate jetting performance of the jetting heads based on jetting conditions of the droplets detected by the camera unit.

14. The jetting performance tester according to claim 13, wherein the two or more cameras are disposed in parallel with each other to detect the droplets ejected by two or more nozzles simultaneously.

15. The jetting performance tester according to claim 13, wherein the two or more cameras are disposed at a predetermined angle with respect to one another to detect a droplet ejected by one nozzle at different angles simultaneously.

16. A jetting system, comprising:
a head unit comprising one or more jetting heads, each having a plurality of nozzles to eject droplets;
a jetting performance testing unit comprising:
a camera unit to measure jetting conditions of the droplets ejected by the nozzles of the jetting heads, and
a driving unit to adjust a position and an angle of the camera unit with respect to the head unit; and
a controller to control the jetting performance testing unit and the head unit and to evaluate a jetting performance of the jetting heads based on the jetting conditions measured by the camera unit.

17. The jetting system according to claim 16, wherein the driving unit adjusts the position of the camera unit with respect to the head unit to sequentially position the camera unit to measure the jetting conditions of droplets of each of nozzles of each jetting head.

18. The jetting system according to claim 16, wherein the driving unit adjusts the position of the camera unit with respect to the head unit by moving the head unit.

19. The jetting system according to claim 16, wherein the driving unit adjust the position of the camera unit with respect to the head unit by moving the camera unit.

20. A jetting system, comprising:
a head unit comprising one or more jetting heads, each having a plurality of nozzles to eject droplets;
a camera unit comprising two or more cameras to measure jetting conditions of the droplets ejected by the nozzles of the jetting heads; and
a driving unit to move one of the head unit and the camera unit to adjust a relative position of the camera unit with respect to the head unit and to rotate the camera unit with respect to the head unit to adjust a measurement angle of each of the two or more cameras.

21. The jetting system according to claim 20, wherein the two or more cameras measure the jetting conditions of droplets ejected from two or more nozzles of one of the jetting heads simultaneously.

22. The jetting system according to claim 20, wherein the two or more cameras measure the jetting conditions of one droplet from two or more measurement angles simultaneously.

23. The jetting system according to claim 20, wherein the driving unit comprises:
a head driving unit to move the head unit in a longitudinal direction the jetting heads and a height direction of the jetting heads; and
a camera driving unit to move the camera in a width direction of the jetting heads and to rotate the camera with respect to the head unit.

24. The jetting system according to claim 20, wherein the driving unit moves the camera in a longitudinal direction of the jetting heads, a width direction of the jetting heads, and a height direction of the jetting heads, and rotates the camera unit with respect to the head unit.

25. A method of testing a jetting performance of a plurality of jetting heads each having a plurality of nozzles to eject droplets, the method comprising:
positioning a plurality of cameras at different angles with respect to the droplets; and
measuring each of the droplets with the plurality of cameras to evaluate the jetting performance of the jetting heads.
